(19) United States
(12) Patent Application Publication
(10) Pub. No.: US 2024/0149217 A1
(43) Pub. Date: May 9, 2024

(54) OCEAN FERTILIZER

(71) Applicant: Rory Korathu-Larson, LLC, Seattle, WA (US)

(72) Inventor: Rory Korathu-Larson, Seattle, WA (US)

(21) Appl. No.: 18/386,958

(22) Filed: Nov. 3, 2023

Related U.S. Application Data
(60) Provisional application No. 63/422,852, filed on Nov. 4, 2022.

(51) Int. Cl. B01D 53/84

(52) U.S. Cl. CPC B01D 53/84; B01D 2251/95; B01D 2255/2047; B01D 2257/504; B01D 2258/06

(57) ABSTRACT

An ocean fertilizer for the indirect sequestration of carbon dioxide in the ocean comprises a compound containing iron, a compound containing nitrogen, a compound containing phosphorus, a magnesium salt, and at least one of an ammonia oxidizing bacteria and a nitrite oxidizing bacteria, or both types of bacteria.

This patent application claims priority benefit of U.S. provisional patent application 63/422,852, filed on Nov. 4, 2022, which is hereby incorporated by reference in its entirety.

### FIELD OF THE INVENTION

This invention relates to ocean fertilizers and more particularly to ocean fertilizers to enhance carbon dioxide sequestration.

### BACKGROUND OF THE INVENTION

Ocean fertilization is a type of technology for carbon dioxide sequestration based on the introduction of plant nutrients to the upper ocean to increase marine food production, which in turn leads to the removal of carbon dioxide from the atmosphere. One known technique is iron fertilization, which is hoped to stimulate photosynthesis in phytoplankton, diatoms, etc. These tiny organisms would convert the ocean's dissolved carbon dioxide into carbohydrates. Because dissolved carbon dioxide is consumed in the photosynthetic process, its levels in the ocean are replenished by carbon dioxide from the atmosphere to maintain a chemical equilibrium. This results in a drawdown of carbon dioxide from the atmosphere into the oceans until equilibrium is restored. Some of the diatoms so formed will sink into the deeper ocean in the form of particulate organic matter. Others would be eaten by additional species up the food chain which eventually would also accumulate on the ocean floor. This approach would typically sequester carbon dioxide on a timescale of 10-100 years dependent on ocean mixing times.

The marine food chain is based on photosynthesis by marine phytoplankton that combine carbon with inorganic nutrients to produce organic matter. Production is limited by the availability of nutrients, most commonly nitrogen and iron. Carbon-to-iron ratios in phytoplankton are much larger than carbon-to-nitrogen or carbon-to-phosphorus ratios, so iron has the highest potential for sequestration per unit mass added.

Several attempts have been made using fertilizers for indirect carbon dioxide sequestration but had relatively poor results, such as lower than expected yield of phytoplankton, and consequently lower than expected indirect carbon dioxide sequestration, along with the potential for side effects due to local overloading of fertilizer. It would therefore be desirable to provide an ocean fertilizer with an enhanced yield of phytoplankton and diatoms.

### SUMMARY OF THE INVENTION

In accordance with a first aspect, an ocean fertilizer for the indirect sequestration of carbon dioxide in the ocean comprises a compound containing iron, a compound containing nitrogen, a compound containing phosphorus, a magnesium salt, and at least one of an ammonia oxidizing bacteria and a nitrite oxidizing bacteria, or both such bacteria.

From the foregoing disclosure and the following more detailed description of various embodiments, it will be apparent to those skilled in the art that the present invention provides a significant advance in the technology of ocean fertilizers. Particularly significant in this regard is the potential the invention affords for providing a reliable ocean fertilizer for increasing carbon dioxide sequestration in the ocean. Additional elements and advantages of various embodiments will be better understood in view of the detailed description provided below.

### DETAILED DESCRIPTION OF CERTAIN EMBODIMENTS

It will be apparent to those skilled in the art, that many uses and design variations are possible for the ocean fertilizer disclosed herein. The following detailed discussion of various alternate elements and embodiments will illustrate the general principles of the invention with reference to an ocean fertilizer suitable for indirect carbon dioxide sequestration. Other embodiments suitable for other applications will be apparent to those skilled in the art given the benefit of this disclosure.

An intended goal of ocean fertilizer is to increase the growth of phytoplankton, which fixes carbon dioxide in the ocean and may ultimately precipitate to the ocean floor directly, or the phytoplankton may be in turn consumed by zooplankton such as krill, which in turn may ultimately precipitate to the ocean floor. Representative examples of targets for fertilization include phytoplankton, for example, a relatively common diatom such as Neodenticula seminae. The effect of such seeding may last for decades.

In accordance with a first aspect, an improved ocean fertilizer is provided which comprises a compound containing iron, a compound containing nitrogen, a compound containing phosphorus, a compound containing magnesium, and at least one of an Ammonia Oxidizing Bacteria, AOB, and a Nitrite Oxidizing Bacteria, NOB, or both. Preferably the iron compound is in the form of ferric ethylenediaminetetraacetic acid, (ferric EDTA). Ferric EDTA has been found to be superior to known iron fertilizers that often use an iron sulphate as their active ingredient. Nitrogen and Phosphorus are also important for phytoplankton growth. A suitable source of nitrogen can be ammonium nitrate, NH₄NO₃, or an ammonium phosphate NH₄(PO₄)₃. The ammonium phosphate can also serve as a source of the phosphate in the fertilizer. A suitable source of magnesium for the ocean fertilizer disclosed herein is the salt magnesium chloride, MgCl₂. Magnesium chloride is added to catalyze the concentration of dissolved carbon dioxide.

Iron, Nitrogen, and Phosphorus, while beneficial for phytoplankton growth, can be toxic in their raw forms, leading to a local dead zone. Therefore, and in accordance with a highly advantageous element, one or more of several types of bacteria may be added to the ocean fertilizer to reduce the likelihood of the formation of such a dead zone, and to help seed the region of the ocean where the fertilizer is added. These bacteria can comprise, for example, an Ammonia Oxidizing Bacteria (AOB), and/or a Nitrite Oxidizing Bacteria (NOB). These bacteria help to jump-start the metabolism process and prevent damage to the local ecosystem that too much iron and nitrogen compounds can produce. Suitable representative and useful examples of Ammonia Oxidizing Bacteria can comprise Nitrosomonas europaea, and suitable representative and useful examples of nitrite oxidizing bacteria can comprise Nitrospina gracilis, for example. The ocean fertilizer may be made by combining both of these bacteria to better prevent dead zones from forming due to localized overdosing. Also, to avoid the creation of localized dead zones, it is desirable to keep the amount of ocean fertilizer added below a predetermined threshold. For example, the ferric EDTA should be kept below 5000 kg per 150 km 2 of ocean volume. For moderate effectiveness, the ferric EDTA should be kept about 1000 kg per 150 km 2 of ocean, but more preferably should be kept above 2000 kg per 150 km 2 of ocean volume but under 5000 kg per 150 km 2 of ocean volume.

In addition to the useful ocean fertilizer disclosed, the method in which the ocean fertilizer is applied to the ocean can make a major impact on the enhanced yield of phytoplankton (and subsequent carbon dioxide sequestration). For example, the ocean fertilizer can be preferentially applied to the ocean at a location in the range of 40-70° North latitude and 40-70° South latitude. Placing the ocean fertilizer too far north and phytoplankton do not grow well. But placing the ocean fertilizer too far south and currents may be unfavorable and other growth may compete such as toxic algal blooms, for example. Another important factor is the thermohaline cycle, where shallow, warm, and relatively low saline currents from the equatorial regions travel north until mixing enough at an end of the cycle at a region of the ocean where the shallow, warm, and low saline current cools sufficiently to transition to a deep, cool, and high saline current. The amounts of dissolved gases such as oxygen and the amounts of phytoplankton are relatively optimized in this region, such that the phytoplankton would be most responsive to fertilization here. Preferably the ocean fertilizer is introduced to the ocean at this region of the ocean where the thermohaline cycle (that is, the warm current moving away from the equator and towards the poles) ends. The fertilizer is preferably placed up-stream of an abyssal cataract which will then in turn, using its downward current, push the carbon to the bottom of the ocean. This placement is preferred so as to give the algae enough lead time to bloom before it reaches the point of maximum carbon sequestration at the bottom of the ocean.

Other important considerations beyond the location and constituents of seawater present are the timing of application of the ocean fertilizer. Generally, it is desirable to apply the ocean fertilizer to the ocean when growth prospects are best for phytoplankton. Thus, the ocean fertilizer can be applied during the summer when light from the sun is strongest and enhances growth. Further, to reduce microbial attrition, the ocean fertilizer can be applied at night.

Although it is envisioned that primary carbon dioxide sequestration may occur by deposits on the sea floor, another way is by culling zooplankton. Zooplankton which eat the phytoplankton can comprise krill and other similar creatures. In accordance with one embodiment of the methods disclosed herein, the zooplankton may be harvested after a sufficient amount of time has passed after the ocean fertilizer has been applied, the phytoplankton has had time to grow, and the zooplankton has had time to eat the phytoplankton.

An amount added for each part of the ocean fertilizer can be tuned for the desired biological response based on the bioenergetic pathways weighted by biomass in the sample. Biomass population is currently defined down to the taxonomic rank of Order. Order gets one in the ballpark of cellular respiration trophic level transfer efficiency and response to environmental conditions. The ocean fertilizers disclosed herein may be limited by maximum tolerances of the species which in intended to be stimulated. Maximum tolerances can be, for example:
Ammonia 8 ppm
Nitrite 5 ppm
Nitrate 160 ppm
Iron 1 ppm
Magnesium 1500 ppm
Phosphorus 1 ppm
   The maximum threshold of survivability of more sensitive marine life, “Gilled” marine life may be far more sensitive than diatomic, planktonic, or microbial life. Therefore, the maximum threshold of survivability may be lower for such gilled marine life may be lower.

From the foregoing disclosure and detailed description of certain embodiments, it will be apparent that various modifications, additions, and other alternative embodiments are possible without departing from the true scope of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An ocean fertilizer for the indirect sequestration of carbon dioxide in the ocean comprising, in combination:
a compound containing iron;
a compound containing nitrogen;
a compound containing phosphorus;
a magnesium salt; and
an ammonia oxidizing bacteria.

2. The ocean fertilizer of claim 1 further comprising a nitrite oxidizing bacteria.

3. The ocean fertilizer of claim 2 wherein the compound containing iron is ferric EDTA.

4. The ocean fertilizer of claim 3 wherein the compound containing nitrogen is one of an ammonium nitrate and an ammonium phosphate.

5. The ocean fertilizer of claim 1 wherein the compound containing phosphorus is an ammonium phosphate.

6. The ocean fertilizer of claim 1 wherein the magnesium salt is magnesium chloride.

7. The ocean fertilizer of claim 1 wherein the ammonia oxidizing bacteria is Nitrosomonas europaea.

8. The ocean fertilizer of claim 2 wherein the nitrate oxidizing bacteria is Nitrospina gracilis.

9. The ocean fertilizer of claim 1 wherein the ocean fertilizer is applied to the ocean at a location in the range of 40-70° North latitude and 40-70° South latitude.

10. The ocean fertilizer of claim 9 wherein the ocean fertilizer is applied to an end of the ocean thermohaline at a region of the ocean where a shallow, warm, and low saline current cools sufficiently to transition to a deep, cool, and high saline current.

11. The ocean fertilizer of claim 10 wherein the ocean fertilizer is applied during the summer.

12. The ocean fertilizer of claim 11 wherein the ocean fertilizer is applied at night.

13. The ocean fertilizer of claim 10 where an amount of applied ferric EDTA is less than 5000 kg per 150 km 2 of ocean.

14. An ocean fertilizer for the indirect sequestration of carbon dioxide in the ocean comprising, in combination:
an iron compound in the form of ferric ethylenediaminetetraacetic add (Ferritic EDTA);
a compound containing nitrogen;
a compound containing phosphorus;
a magnesium salt; and
a nitrite oxidizing bacteria.

15. The ocean fertilizer of claim 14 further comprising an ammonia oxidizing bacteria, and both the compound containing nitrogen and the compound containing phosphorus is an ammonium phosphate.
